(19) United States
(12) Patent Application Publication
(10) Pub. No.: US 2018/0181871 A1
(43) Pub. Date: Jun. 28, 2018

(54) APPARATUS AND METHOD FOR DETECTING ABNORMAL EVENT USING STATISTICS

(71) Applicant: FutureSystems, Inc., Seongnam-si (KR)

(72) Inventor: Moon Chang Chae, Gunpo-si (KR)

(21) Appl. No.: 15/415,159

(22) Filed: Jan. 25, 2017

(30) Foreign Application Priority Data
Dec. 22, 2016 (KR) 10-2016-0176991

(51) Int. Cl. G06N 5/04; G06N 7/00

(52) U.S. Cl. CPC G06N 5/04; G06N 7/005

(57) ABSTRACT

Provided is a method of detecting an abnormal event based on statistics, the method including determining types of events occurring in event occurrence devices based on event information received from the event occurrence devices, grouping events in unverifiable types into at least one event group based on a similarity between the event, and detecting an abnormal event based on an occurring frequency of the event group or an occurring frequency of events corresponding to the same type.

### CROSS-REFERENCE TO RELATED APPLICATION(S)

This application claims the priority benefit of Korean Patent Application No. 10-2016-0176991 filed on Dec. 22, 2016, in the Korean Intellectual Property Office, the disclosure of which is incorporated herein by reference for all purposes.

### BACKGROUND

### 1. Field

One or more example embodiments relate to a method and apparatus for detecting an abnormal event based on statistics related to an event.

### 2. Description of Related Art

In devices such as network equipment and security equipment including the Internet of things (IoT), various types of events may occur at an interval of a preset period of time. Events may increase according to an increase in user accesses, operations or hacking attacks such as a distributed denial of service attack (DDOS). An event occurring due to the hacking attack or an unexpected situation may be referred to as an abnormal event. To cope with the abnormal event, technology for detecting an occurrence of the abnormal event has been required.

Although there has been provided a rule-based abnormal event detection method such as a complex event processing (CEP), the rule-based abnormal event detection method is applicable to not various systems but a specific system because different events occur based on a service or equipment.

Accordingly, there is a desire for a method of detecting an abnormal event in various systems.

### SUMMARY

An aspect provides a method and apparatus for grouping events in unverifiable types into an event group based on a similarity between items of event information, measuring an occurring frequency of the event group, and detecting an occurrence of an abnormal event related to the corresponding events.

According to an aspect, there is provided a method of detecting an abnormal event, the method including determining types of events occurring in event occurrence devices based on event information received from the event occurrence devices, grouping events in unverifiable types into at least one event group based on a similarity between the event, and detecting an abnormal event based on an occurring frequency of the event group or an occurring frequency of events corresponding to the same type.

The determining may include separating the event information in a character string type into a plurality of terms configuring the event information, searching the separated terms for a term related to an event information type, and determining a type of an event based on the found term.

The determining may include verifying that the type of the event corresponding to the event information is not to be determined when the term related to the event information type is not found.

The grouping may include determining a similarity between terms separated from each item of the event information, and grouping event information corresponding to a similarity between the terms greater than a threshold.

The method may further include measuring an event occurring frequency of each of the event occurrence devices based on the event information received from the event occurrence devices, and detecting the abnormal event based on the event occurring frequency of each of the event occurrence devices.

The detecting may include determining a first confidence interval using a plurality of items of event information receives most recently based on the event information and determining whether the event information is included in the first confidence interval, determining a second confidence interval using a plurality of items of event information corresponding to the same period of time or season as that of the event information and determining whether the event information is included in the second confidence interval, and determining whether the event information corresponds to the abnormal event based on whether the event information is included in the first confidence interval and whether the event information is included in the second confidence interval.

The determining of whether the event information corresponds to the abnormal event may include determining that the event information corresponds to the abnormal event when the event information is not included in the second confidence interval, determining that the event information corresponds to a normal event when the event information is not included in the first confidence interval and is included in the second confidence interval, and determining that the event information corresponds to the normal event when the event information is included in the first confidence interval.

The detecting may further include determining a third confidence interval using a plurality of items of event information included in the same event group as the event information and determining whether the event information is included in the third confidence interval, and the determining of whether the event information corresponds to the abnormal event may include determining the event information corresponds to the abnormal event when the event information is not included in the third confidence interval and is included in the first confidence interval.

According to another aspect, there is also provided an apparatus for detecting an abnormal event, the apparatus including a communicator configured to receive event information from event occurrence devices, and a processor configured to determine types of events occurring in event occurrence devices based on the event information, groups events in unverifiable types into at least one event group based on a similarity between the event, and detect an abnormal event based on an occurring frequency of the event group or an occurring frequency of events corresponding to the same type.

The processor may be configured to separate the event information in a character string type into a plurality of terms configuring the event information, search the separated terms for a term related to an event information type, and determine a type of an event based on the found term.

The processor may be configured to verify that the type of the event corresponding to the event information is not to be determined when the term related to the event information type is not found.

The processor may be configured to measure an event occurring frequency of each of the event occurrence devices based on the event information received from the event occurrence devices, and detect the abnormal event based on the event occurring frequency of each of the event occurrence devices.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an abnormal event detection system according to an example embodiment;

FIG. 2 is a diagram illustrating an abnormal event detection apparatus according to an example embodiment;

FIG. 3 is a diagram illustrating an example of determining a type of event according to an example embodiment;

FIG. 4 is a diagram illustrating another example of determining a type of event according to an example embodiment;

FIG. 5 is a diagram illustrating still another example of determining a type of event according to an example embodiment;

FIG. 6 is a diagram illustrating yet another example of determining a type of event according to an example embodiment;

FIG. 7 is a diagram illustrating an example of measuring an event occurring frequency for each event occurrence device according to an example embodiment;

FIG. 8 is a diagram illustrating an example of measuring an event occurring frequency for each type of event according to an example embodiment;

FIG. 9 is a diagram illustrating an example of measuring an event occurring frequency for each event group according to an example embodiment;

FIG. 10 is a flowchart illustrating an abnormal event detection method according to an example embodiment;

FIG. 11 is a flowchart illustrating a procedure of detecting an abnormal event in an abnormal event detection method according to an example embodiment;

FIG. 12 is a diagram illustrating an example of determining whether current event information corresponds to an abnormal event using items of event information corresponding to the same period according to an example embodiment; and

FIG. 13 is a diagram illustrating an example of determining whether current event information corresponds to an abnormal event using event information included in an event group according to an example embodiment.

### DETAILED DESCRIPTION

Hereinafter, some example embodiments will be described in detail with reference to the accompanying drawings. An abnormal event detection method may be performed by an abnormal event detection apparatus.

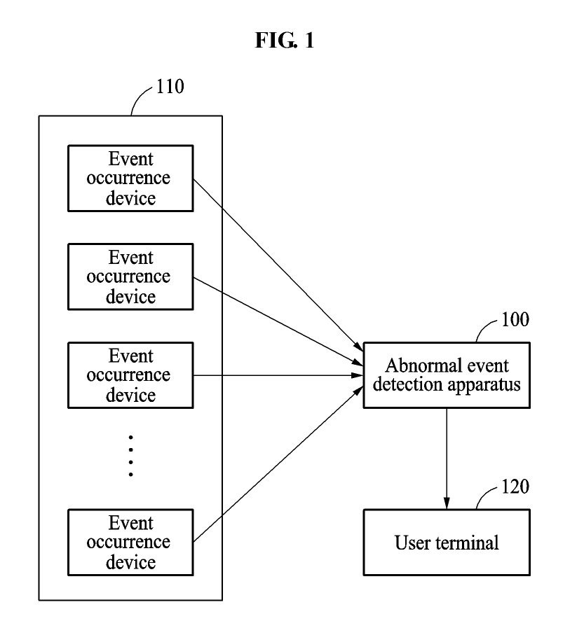

FIG. 1 is a diagram illustrating an abnormal event detection system according to an example embodiment.

Referring to FIG. 1, an abnormal event detection apparatus 100 may receive event information from a plurality of event occurrence devices 110. The event occurrence devices 110 may include at least one of service providing devices or equipments such as an Internet of things (IoT) device, a machine to machine (M2M) device, a sensor, a power measuring device, network equipment, security equipment, a host, and the like, for example. Also, even when the event occurrence devices 110 are the same, different events may occur in the event occurrence devices 110 based on equipment or a service provided to a user.

Event information may be information associated with an event occurring in each of the event occurrence devices 110. For example, the event information may be a character string representing the event occurring in each of the event occurrence devices 110 or a character string into which a binary event is converted.

The abnormal event detection apparatus 100 may determine types of events using event information received from the event occurrence devices 110, and group events in unverifiable types into a plurality of event groups.

Subsequently, the abnormal event detection apparatus 100 may measure at least one of an occurring frequency of an abnormal event for each of the event occurrence devices 110, an occurring frequency of an abnormal event for each of the event groups, or an occurring frequency of an abnormal event for each of the types of events. Also, the abnormal event detection apparatus 100 may determine whether the abnormal event occurs based on the measured occurring frequency of the abnormal event.

When it is determined that the abnormal event occurs, the abnormal event detection apparatus 100 may send a notification message indicating that the abnormal event occurs to a user terminal 120. In response to the message being received from the abnormal event detection apparatus 100, the user terminal 120 may provide notification on an occurrence of the abnormal event to a user.

An abnormal event detection apparatus may group events in unverifiable types into an event group based on a similarity between items of event information, measure an occurring frequency of the event group, and detect an occurrence of an abnormal event related to the corresponding events.

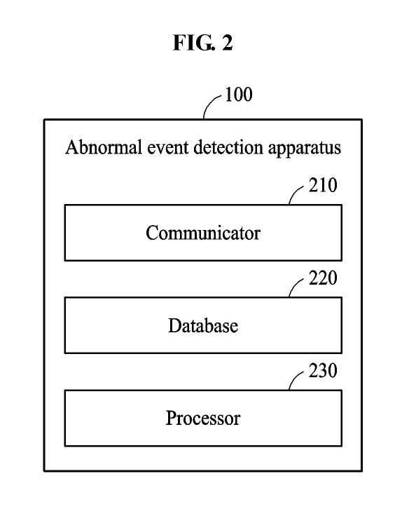

FIG. 2 is a diagram illustrating an abnormal event detection apparatus according to an example embodiment.

Referring to FIG. 2, the abnormal event detection apparatus 100 may include a communicator 210, a database 220, and a processor 230.

The communicator 210 may be connected to the event occurrence devices 110 through a wired network or a wireless network to receive event information in real time or at an interval of a preset period. The communicator 210 may store received event information in the database 220. The preset period may be at least one of, for example, a second, a minute, an hour, a week, a month, a year, and a season.

The database 220 may be implemented as a big-data storage such as a cloud. Using the big-data storage, the abnormal event detection apparatus 100 may provide a service of distributively storing event information input periodically.

The processor 230 may determine types of events occurring in the event occurrence devices 110 based on event information received from the event occurrence devices 110. The processor 230 may separate event information in a type of character string into a plurality of terms configuring the event information and search the separated terms for a term related to an event information type. Also, the processor 230 may determine a type of an event based on the found term. Also, the term related to the event information type may differ for each of the event occurrence devices 110 or depending on a site in which the event occurs.

For example, among the terms separated from the event information, the processor 230 may determine a term corresponding to at least one of event type, msg, action, and risk to be the term related to the event information type.

Also, the processor 230 may group events of which types have not been determined among the event information received from the event occurrence devices 110, into at least one event group based on a similarity between the events.

The processor 230 may measure an occurring frequency of each event group or an occurring frequency of events corresponding to the same type among events of which types have been determined.

The processor 230 may detect an abnormal event based on an occurring frequency of the events corresponding to the same type or the occurring frequency of each event group.

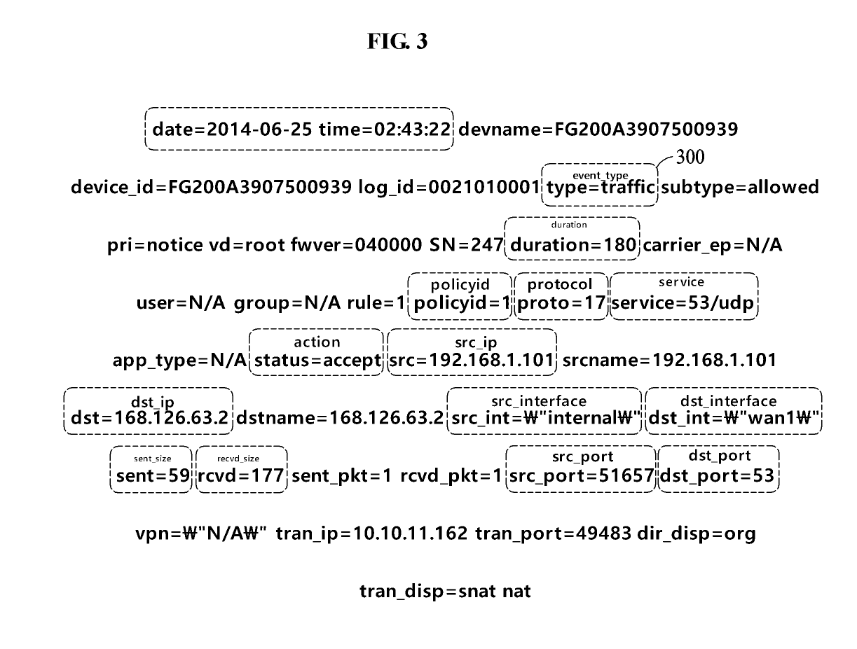

FIG. 3 is a diagram illustrating an example of determining a type of event according to an example embodiment.

The communicator 210 may receive event information in a type of character string as illustrated in FIG. 3 and store the event information in the database 220. The processor 230 may separate the event information stored in the database 220 into terms as indicated by dotted boxes.

The processor 230 may determine a term 300 corresponding to an event type among the terms to be a term related to an event information type. For example, the processor 230 may determine the event information type to be a traffic-related event based on the term 300.

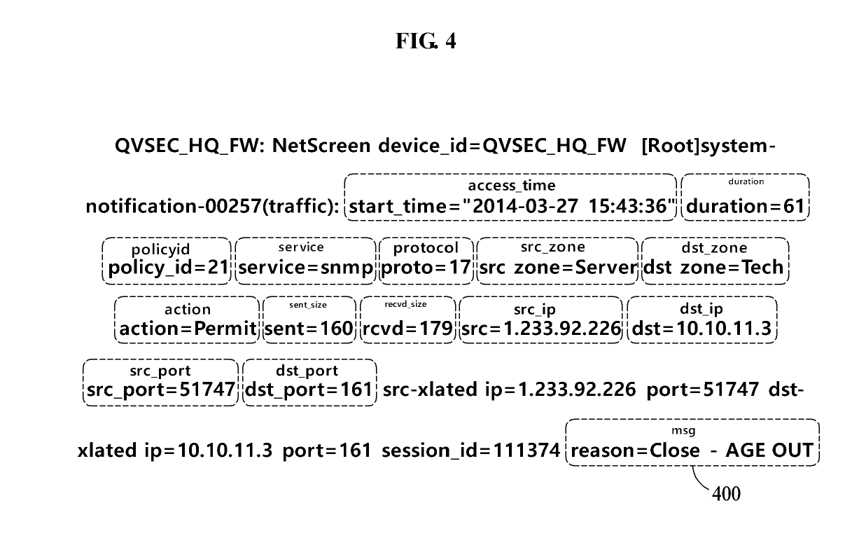

FIG. 4 is a diagram illustrating another example of determining a type of event according to an example embodiment.

The communicator 210 may receive event information in a type of character string as illustrated in FIG. 4 and store the event information in the database 220. The processor 230 may separate the event information stored in the database 220 into terms as indicated by dotted boxes.

The processor 230 may determine a term 400 corresponding to “msg” among the terms to be a term related to an event information type.

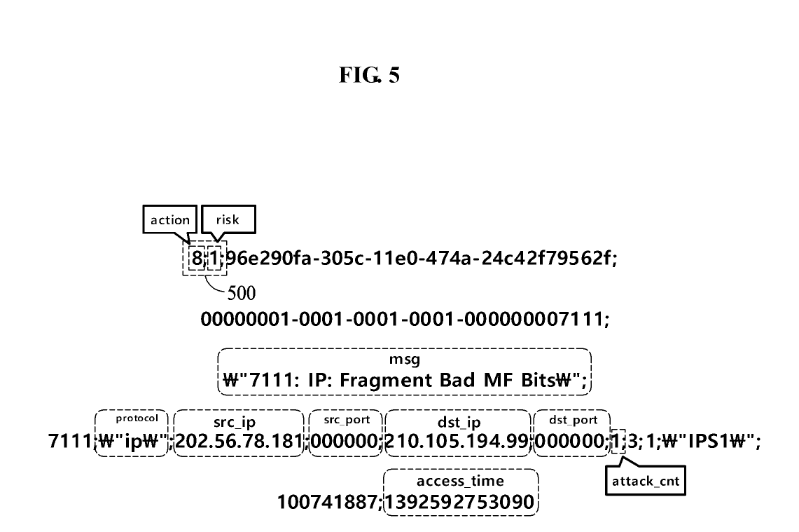

FIG. 5 is a diagram illustrating still another example of determining a type of event according to an example embodiment.

The processor 230 may separate character-string-type event information stored in the database into terms as indicated by dotted boxes of FIG. 5.

The processor 230 may determine a term 500 in a form of combination “action:risk” of a character corresponding to “action” and a character corresponding to “risk”, to be a term related to an event information type.

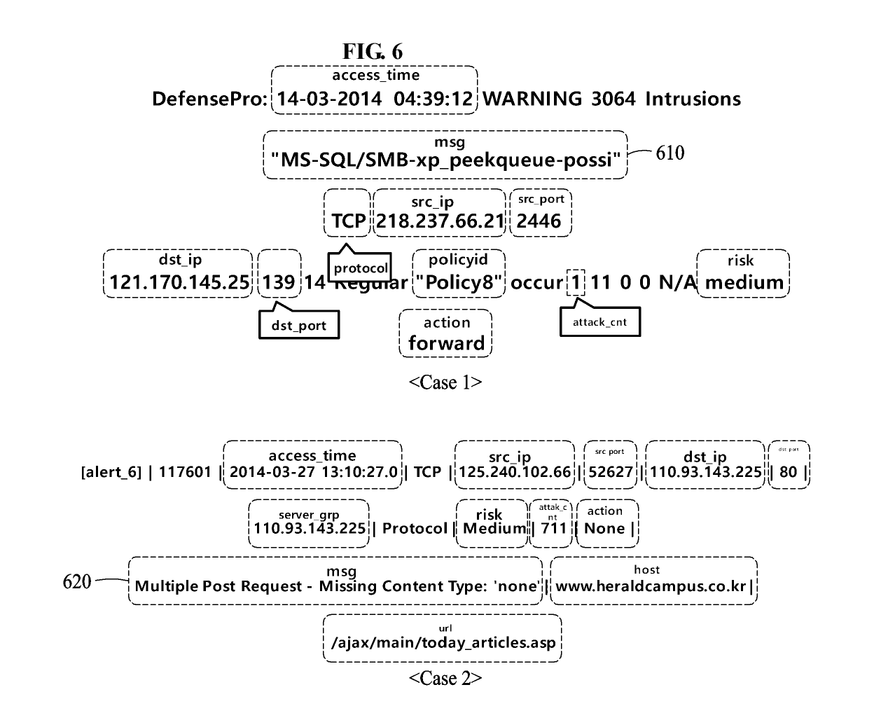

FIG. 6 is a diagram illustrating yet another example of determining a type of event according to an example embodiment.

The processor 230 may separate character-string-type event information of Case 1 and separate character-string-type event information of Case 2 stored in the database 220, into terms as indicated by dotted boxes of FIG. 6.

The processor 230 may determine a type of event corresponding to the Case 1 using a term 610 corresponding to “msg” among the terms as shown in the Case 1. Also, the processor 230 may determine a type of event corresponding to the Case 1 using a term 620 corresponding to “msg” among the terms as shown in the Case 2.

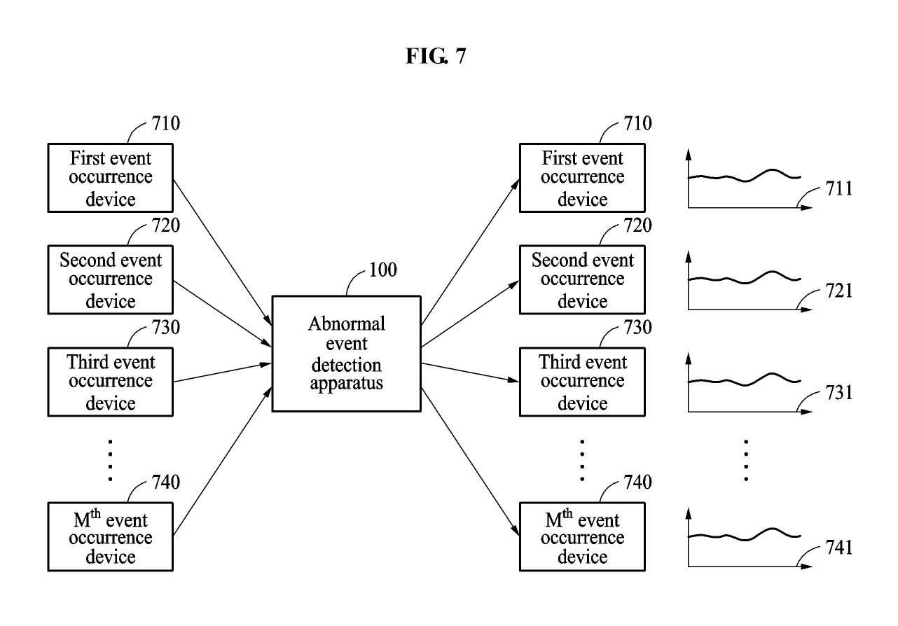

FIG. 7 is a diagram illustrating an example of measuring an event occurring frequency for each event occurrence device according to an example embodiment.

The abnormal event detection apparatus 100 may measure an event occurrence frequency for each event occurrence device. In this example, the event occurrence devices 110 may include M event occurrence devices, M being an integer. Here, M may vary based on a number of event occurrence devices requesting an abnormal event detection system to detect an abnormal event. Referring to FIG. 7, the event occurrence devices 110 may include, for example, a first event occurrence device 710, a second event occurrence device 720, and a third event occurrence device 730 through an Mth event occurrence device 740.

Specifically, the abnormal event detection apparatus 100 may measure an occurring frequency 711 of each item of the event information received from the first event occurrence device 710. Also, when an event that has not occur in the first event occurrence device 710 occurs, or when events additionally occur or decrease by a number of events exceeding an error range in comparison to the number of events occurring in the first event occurrence device 710, the abnormal event detection apparatus 100 may determine that an abnormal event occurs in the first event occurrence device 710.

Also, the abnormal event detection apparatus 100 may measure occurring frequencies 721 through 741 of the second event occurrence device 720 through the Mth event occurrence device 740, respectively. By applying a similar or identical method used for the first event occurrence device 710 to the occurring frequencies 721 through 741, the abnormal event detection apparatus 100 may determine whether an abnormal event occurs in each of the second event occurrence device 720 through the Mth event occurrence device 740.

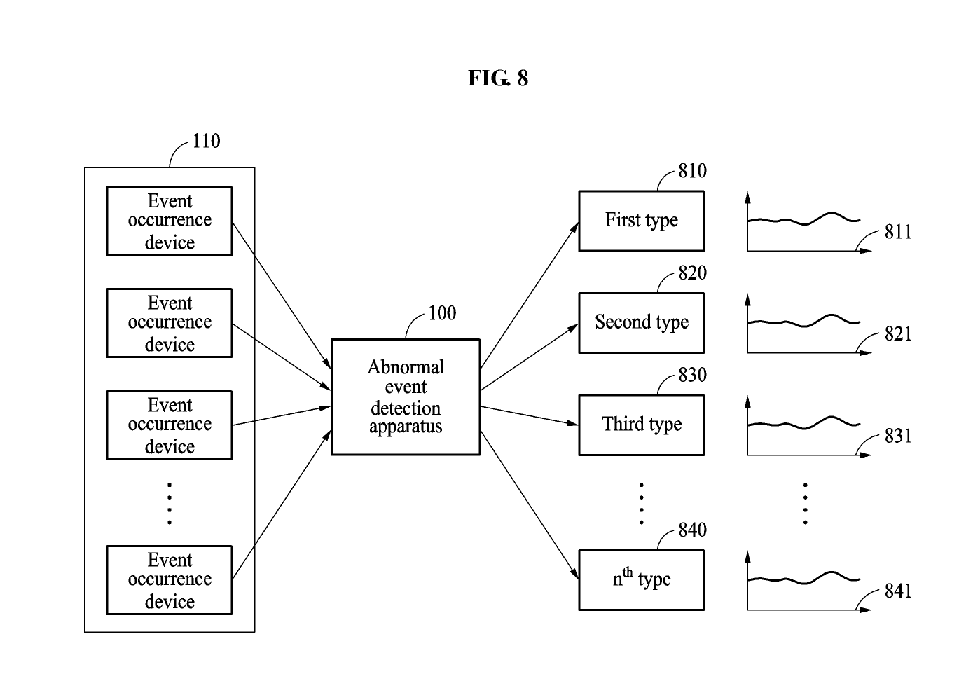

FIG. 8 is a diagram illustrating an example of measuring an event occurring frequency for each type of event according to an example embodiment.

The abnormal event detection apparatus 100 may determine a type of an event occurring in each of the event occurrence devices 110 based on event information received from the event occurrence devices 110. The abnormal event detection apparatus 100 may measure an event occurring frequency for each type of event. The event occurrence devices 110 may classify events into n types of events, n being an integer. Here, n may be determined based on the number of event types to be determined by the abnormal event detection apparatus 100.

Specifically, the abnormal event detection apparatus 100 may measure an occurring frequency 811 of a first type 810 among the types of events. When the occurring frequency 811 of the first type 810 increases or decreases to exceed an error range, the abnormal event detection apparatus 100 may determine that an abnormal event corresponding to the first type 810 occurs.

The abnormal event detection apparatus 100 may measure occurring frequencies 821 through 841 of a second type 820 through an nth type 840, respectively. By applying a similar or identical method used for the first type 810 to the occurring frequencies 821 through 841, the abnormal event detection apparatus 100 may determine whether an abnormal event occurs for each of the second type 820 through the nth type 840. In this example, the first type 810 through the nth type 840 are used to classify types of events as an example and thus, may also be replaced with, for example, identification information or names corresponding to the types of events in practice.

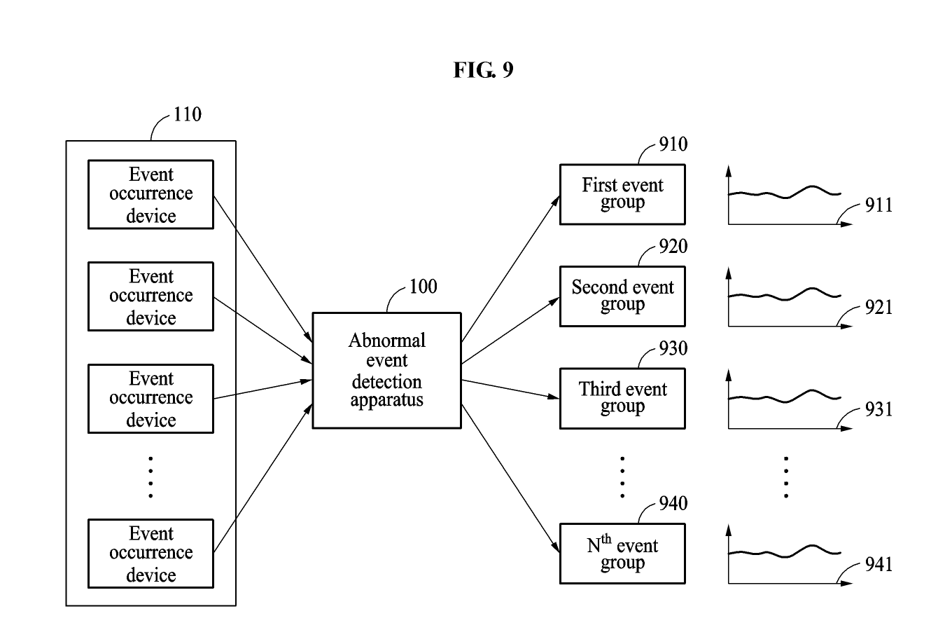

FIG. 9 is a diagram illustrating an example of measuring an event occurring frequency for each event group according to an example embodiment.

The abnormal event detection apparatus 100 may determine a type of an event occurring in each of the event occurrence devices 110 based on event information received from the event occurrence devices 110. Subsequently, the abnormal event detection apparatus 100 may group events in unverifiable types into at least one event group based on a similarity between the events. The abnormal event detection apparatus 100 may measure an event occurring frequency for each event group. The event occurrence devices 110 may generate N event groups, N being an integer. Here, N may be determined based on the number of event groups to be generated by the abnormal event detection apparatus 100.

Specifically, the abnormal event detection apparatus 100 may measure an occurring frequency 911 of a first event group 910 among the event groups. When the occurring frequency 911 of the first event group 910 increases or decreases to exceed an error range, the abnormal event detection apparatus 100 may determine that an abnormal event corresponding to the first event group 910 occurs.

The abnormal event detection apparatus 100 may measure occurring frequencies 921 through 941 of a second event group 920 through an Nth event group 940, respectively. By applying a similar or identical method used for the first event group 910 to the occurring frequencies 921 through 941, the abnormal event detection apparatus 100 may determine whether an abnormal event occurs for each of the second event group 920 through the Nth type 940. In this example, the first event group 910 through the Nth type 940 are used to classify types of events as an example and thus, may also be replaced with, for example, identification information or names corresponding to the types of events in practice.

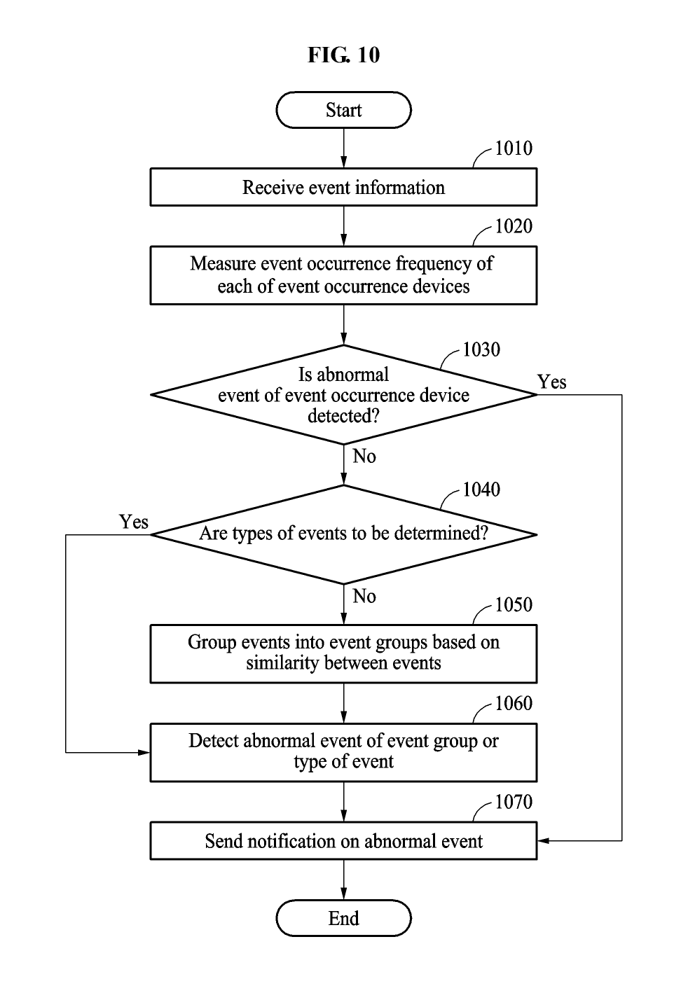

FIG. 10 is a flowchart illustrating an abnormal event detection method according to an example embodiment.

In operation 1010, the abnormal event detection apparatus 100 may receive event information from the event occurrence devices 110.

In operation 1020, the abnormal event detection apparatus 100 may measure an event occurrence frequency of each of the event occurrence devices having transmitted the event information.

In operation 1030, based on the event occurrence frequency of each of the event occurrence devices measured in operation 1020, the abnormal event detection apparatus 100 may determine whether an abnormal event of the corresponding event occurrence device is detected. When an event that has not occurred in each of the event occurrence devices 110 occurs, or when events additionally occur or decrease by a number of events exceeding an error range in comparison to the number of events occurring in each of the event occurrence devices, the abnormal event detection apparatus 100 may determine that the abnormal event occurs in the corresponding event occurrence device.

When it is determined that the abnormal event occurs in at least one of the event occurrence devices 110, the abnormal event detection apparatus 100 may perform operation 1070. When it is determined that the abnormal event does not occur in the event occurrence devices 110, the abnormal event detection apparatus 100 may perform operation 1040.

In operation 1040, the abnormal event detection apparatus 100 may verify whether types of events occurring in the event occurrence devices 110 are to be determined based on the event information received in operation 1010.

Specifically, the abnormal event detection apparatus 100 may separate event information of a character string type into a plurality of terms configuring the event information and search the separated terms for a term related to an event information type. Also, the processor 230 may determine a type of event based on the found term. In this instance, the abnormal event detection apparatus 100 may perform operation 1060.

When the term related to the event information type is not found from the separated terms, the abnormal event detection apparatus 100 may verify that the type of event corresponding to the event information is not to be determined.

In this instance, the abnormal event detection apparatus 100 may perform operation 1050.

In operation 1050, the abnormal event detection apparatus 100 may group events in unverifiable types in operation 1040 into at least one event group based on a similarity between the events. The abnormal event detection apparatus 100 may determine a similarity between terms separated from the event information. Subsequently, the abnormal event detection apparatus 100 may determine a similarity between events including the terms based on the similarity between the terms. Also, the abnormal event detection apparatus 100 may group events corresponding to a similarity greater than or equal to a threshold into event groups.

In operation 1060, the abnormal event detection apparatus 100 may measure an occurring frequency of events corresponding to the same type or an occurring frequency of an event group, and detect the abnormal event based on the measured occurring frequency.

Specifically, the abnormal event detection apparatus 100 may measure an occurring frequency for each type of event. Also, an occurring frequency of the same type increases or decreases to exceed an error range, the abnormal event detection apparatus 100 may determine that the abnormal event of the corresponding type occurs. Also, the abnormal event detection apparatus 100 may measure an occurring frequency for each event group. When an occurring frequency of an event included in the same event group increases or decreases to exceed an error range, the abnormal event detection apparatus 100 may determine that the abnormal event of the corresponding event group occurs.

In operation 1070, the abnormal event detection apparatus 100 may send, to the user terminal 120, a notification indicating the abnormal event detected in operation 1030 or 1060 so as to be provided to a user.

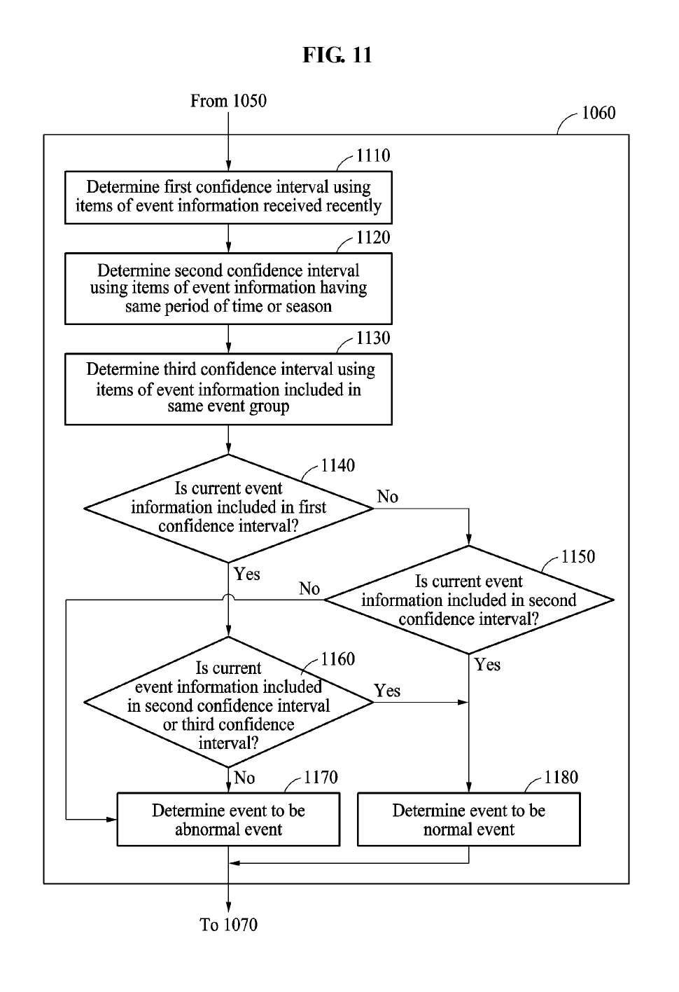

FIG. 11 is a flowchart illustrating a procedure of detecting an abnormal event in an abnormal event detection method according to an example embodiment. Operations 1110 through 1180 of FIG. 11 may be included in a process of determining whether an abnormal event of an event occurrence device is detected in operation 1030 or 1060 of FIG. 10.

In operation 1110, the abnormal event detection apparatus 100 may determine a first confidence interval using a plurality of items of event information received the most recently based on the event information received in operation 1010.

Specifically, when the event information received in operation 1010 is defined as current time event information, the abnormal event detection apparatus 100 may calculate an average and a standard deviation of event information received during a previous time set based on a current time. The previous time set based on the current time may be one of, for example, n hours, n days, and n times.

Also, the abnormal event detection apparatus 100 may calculate the first confidence interval based on the calculated average and standard deviation.

In operation 1120, the abnormal event detection apparatus 100 may determine a second confidence interval using a plurality of items of event information corresponding to the same period of time or season as that of the event information received in operation 1010. The period of time may be a period repeats every day such as a commuting hour and a working hour. A season may be one of a week, a month, one meteorological season, and a year. A period of season may be a period during which people are likely to take a specific action, such as a weekend of a week or a holiday of a year.

When the event information received in operation 1010 is defined as current time event information, the abnormal event detection apparatus 100 may calculate an average and a standard deviation of event information received in the same period of time to which the current time belongs. Also, the abnormal event detection apparatus 100 may calculate the second confidence interval based on the calculated average and standard deviation.

For example, when the current time corresponds to an office-going hour, the abnormal event detection apparatus 100 may calculate an average and a standard deviation of event information received during the office-going hour for several days or several months, and calculate the second confidence interval based on the calculated average and standard deviation. When the current time corresponds to the weekend, the abnormal event detection apparatus 100 may calculate an average and a standard deviation of event information received at the same time as the current time of the weekend for several weeks or several months, and calculate the second confidence interval based on the calculated average and standard deviation. When the current time corresponds to the holyday such as a new year's day and a thanksgiving day, the abnormal event detection apparatus 100 may calculate an average and a standard deviation of event information received in the same period of time as the current time of the holiday for several years, and calculate the second confidence interval based on the calculated average and standard deviation.

In operation 1130, the abnormal event detection apparatus 100 may determine a third confidence interval using a plurality of items of event information included in the same event group as the event information received in operation 1010. When the event information is grouped as an event group in operation 1050, the abnormal event detection apparatus 100 may calculate an average and a standard deviation of event information included in the event group and calculate the second confidence interval based on the calculated average and standard deviation.

In operation 1140, the abnormal event detection apparatus 100 determines whether current event information is included in the first confidence interval. When the current event information is included in the first confidence interval, the abnormal event detection apparatus 100 may perform operation 1160. When the current event information is not included in the first confidence interval, the abnormal event detection apparatus 100 may perform operation 1150.

When the third confidence interval is not calculated and the event information is included in the first confidence interval, the abnormal event detection apparatus 100 may determine that the event information corresponds to a normal event and perform operation 1180.

In operation 1150, the abnormal event detection apparatus 100 may determine whether the current event information is included in the second confidence interval. When the current event information is included in the second confidence interval, the abnormal event detection apparatus 100 may perform operation 1180. When the current event information is not included in the second confidence interval, the abnormal event detection apparatus 100 may perform operation 1170.

When the current event information is not included in either the first confidence interval or the second confidence interval, or when the current event information is not included in either the first confidence interval or the third confidence interval, it is understood that the current event information differs from recent event information, an event history, and events having a high similarity. Thus, the abnormal event detection apparatus 100 may determine that the current event information corresponds to the abnormal event. When the current event information is not included in the first confidence interval and is included in the third confidence interval, it is understood that a current event is abnormal even though the current event information is determined as normal in an event group unit. Also, since the current event information is not included in the second confidence interval, the abnormal event detection apparatus 100 determines that the current event information corresponds to the abnormal event.

When the current event information is not included in the first confidence interval and is included in the second confidence interval, it is understood that the current event information differs from the recent event information and a change in the current event information is within a range corresponding to the event history. Also, the change in the current event information may be a normal change that occurs at intervals of the period of time or the period of season. Accordingly, the abnormal event detection apparatus 100 may determine that the current event information corresponds to the normal event.

In operation 1160, the abnormal event detection apparatus 100 may determine whether the current event information is included in the second confidence interval or the third confidence interval. When the current event information is included in the second confidence interval or the third confidence interval, the abnormal event detection apparatus 100 may perform operation 1180. When the current event information is not included in the third confidence interval, the abnormal event detection apparatus 100 may perform operation 1170.

When the current event information is included in the first confidence interval and is not included in the second confidence interval or the third confidence interval, it is understood that the recent event information is inapplicable to determine whether the current event information is abnormal since all recent event information continuously changes in comparison with a past history. In this instance, the current event information being not included in the second confidence interval may indicate that the current event information has changed compared with the event information corresponding to the same period of time or season. Thus, the abnormal event detection apparatus 100 may determine that the current event information corresponds to the abnormal event. Also, the current event information being not included in the third confidence interval may indicate that the current event information has changed compared with event information included in the same event group. Thus, the abnormal event detection apparatus 100 may determine that the current event information corresponds to the abnormal event.

When the current event information is included in the first confidence interval and is included in the second confidence interval or the third confidence interval, it is understood that the recent event information corresponds to the event history or the events having a high similarity. Accordingly, the abnormal event detection apparatus 100 may determine that the current event information corresponds to the normal event.

In operation 1170, the abnormal event detection apparatus 100 may determine an event corresponding to the current event information to be the abnormal event.

In operation 1180, the abnormal event detection apparatus 100 may determine the event corresponding to the current event information to be the normal event.

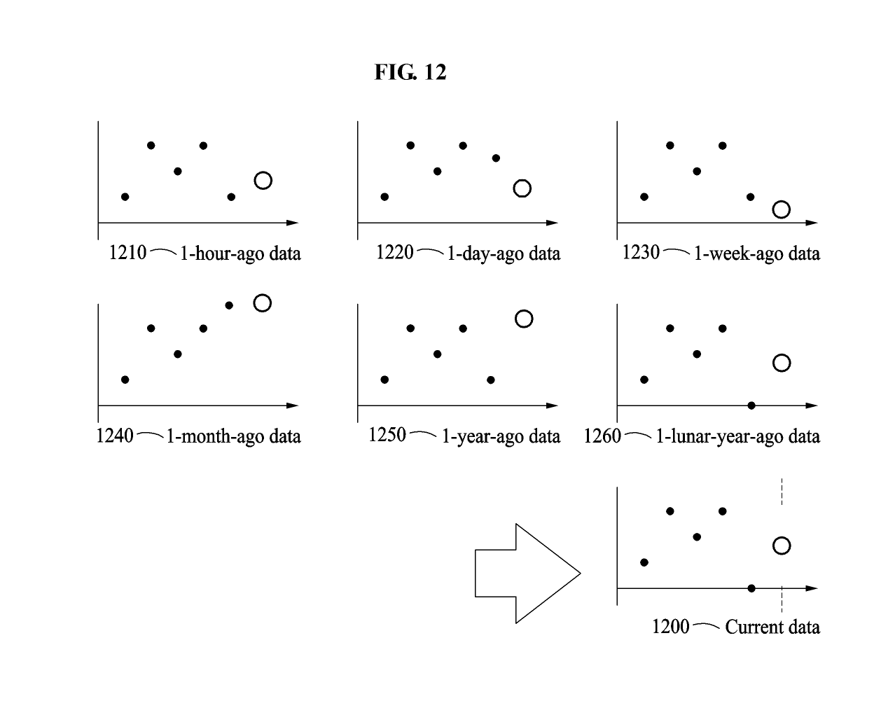

FIG. 12 is a diagram illustrating an example of determining whether current event information corresponds to an abnormal event using items of event information corresponding to the same period according to an example embodiment.

Referring to FIG. 12, the abnormal event detection apparatus 100 may compare current data 1200 to data corresponding to the same period of time as that of the current data 1200 among 1-hour-ago data 1210, 1-day-ago data 1220, 1-week-ago data 1230, 1-month-ago data 1240, 1-year-ago data 1250, and 1-lunar-year-ago data 1260.

For example, the abnormal event detection apparatus 100 may calculate an average and a standard deviation of events that occur during the same time on weekdays or weekends using the 1-day-ago data 1220 and the 1-week-ago data 1230, and set a confidential interval based on the calculated average and standard deviation. The abnormal event detection apparatus 100 may verify whether the current data 1200 is included in the confidence interval and verify whether the current data 1200 is abnormal data.

The abnormal event detection apparatus 100 may calculate an average and a standard deviation of events that occur during fixed holidays using the 1-year-ago data 1250, and set a confidential interval based on the calculated average and standard deviation. The abnormal event detection apparatus 100 may verify whether the current data 1200 is included in the confidence interval and verify whether the current data 1200 is abnormal data.

The abnormal event detection apparatus 100 may calculate an average and a standard deviation of events that occur during traditional holidays using the 1-lunar-year-ago data 1260, and set a confidential interval based on the calculated average and standard deviation. The abnormal event detection apparatus 100 may verify whether the current data 1200 is included in the confidence interval and verify whether the current data 1200 is abnormal data.

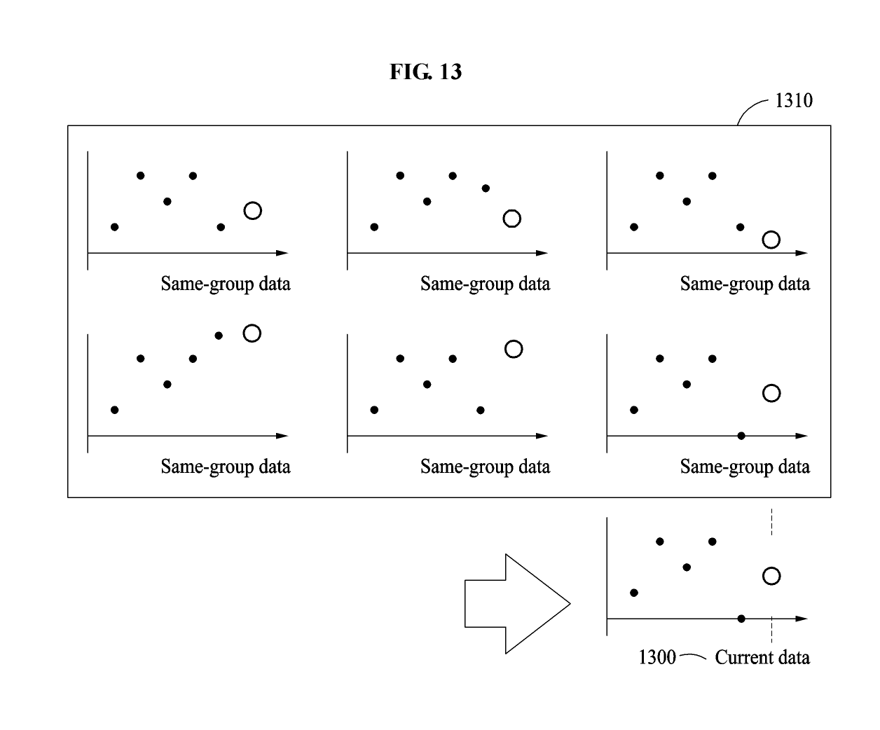

FIG. 13 is a diagram illustrating an example of determining whether current event information corresponds to an abnormal event using event information included in an event group according to an example embodiment.

When event information is grouped into event groups, the abnormal event detection apparatus 100 may calculate an average and a standard deviation of event information included in an event group 1310. Also, the abnormal event detection apparatus 100 may calculate a third confidence interval based on the calculated average and standard deviation. When current event information 1300 is not included in the third confidence interval of the event group 1310, the abnormal event detection apparatus 100 may determine that the current event information 1300 corresponds to an abnormal event.

According to an aspect, it is possible to group events in unverifiable types into an event group based on a similarity between event information, measure an occurring frequency of the event group, and detect an occurrence of an abnormal event related to the corresponding events.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of detecting an abnormal event, the method comprising:
determining types of events occurring in event occurrence devices based on event information received from the event occurrence devices;
grouping events in unverifiable types into at least one event group based on a similarity between the event; and
detecting an abnormal event based on an occurring frequency of the event group or an occurring frequency of events corresponding to the same type.

2. The method of claim 1, wherein the determining includes:
separating the event information in a character string type into a plurality of terms configuring the event information;
searching the separated terms for a term related to an event information type; and
determining a type of an event based on the found term.

3. The method of claim 2, wherein the determining includes:
verifying that the type of the event corresponding to the event information is not to be determined when the term related to the event information type is not found.

4. The method of claim 2, wherein the grouping includes:
determining a similarity between terms separated from each item of the event information; and
grouping event information corresponding to a similarity between the terms greater than a threshold.

5. The method of claim 1, further comprising:
measuring an event occurring frequency of each of the event occurrence devices based on the event information received from the event occurrence devices; and
detecting the abnormal event based on the event occurring frequency of each of the event occurrence devices.

6. The method of claim 1, wherein the detecting includes:
determining a first confidence interval using a plurality of items of event information receives most recently based on the event information and determining whether the event information is included in the first confidence interval;
determining a second confidence interval using a plurality of items of event information corresponding to the same period of time or season as that of the event information and determining whether the event information is included in the second confidence interval; and
determining whether the event information corresponds to the abnormal event based on whether the event information is included in the first confidence interval and whether the event information is included in the second confidence interval.

7. The method of claim 6, wherein the determining of whether the event information corresponds to the abnormal event includes determining that the event information corresponds to the abnormal event when the event information is not included in the second confidence interval, determining that the event information corresponds to a normal event when the event information is not included in the first confidence interval and is included in the second confidence interval, and determining that the event information corresponds to the normal event when the event information is included in the first confidence interval.

8. The method of claim 6, wherein the detecting further includes determining a third confidence interval using a plurality of items of event information included in the same event group as the event information and determining whether the event information is included in the third confidence interval, and
the determining of whether the event information corresponds to the abnormal event includes determining the event information corresponds to the abnormal event when the event information is not included in the third confidence interval and is included in the first confidence interval.

9. An apparatus for detecting an abnormal event, the apparatus comprising:
a communicator configured to receive event information from event occurrence devices; and
a processor configured to determine types of events occurring in event occurrence devices based on the event information, groups events in unverifiable types into at least one event group based on a similarity between the event, and detect an abnormal event based on an occurring frequency of the event group or an occurring frequency of events corresponding to the same type.

10. The apparatus of claim 9, wherein the processor is configured to separate the event information in a character string type into a plurality of terms configuring the event information, search the separated terms for a term related to an event information type, and determine a type of an event based on the found term.

11. The apparatus of claim 10, wherein the processor is configured to verify that the type of the event corresponding to the event information is not to be determined when the term related to the event information type is not found.

12. The apparatus of claim 9, wherein the processor is configured to measure an event occurring frequency of each of the event occurrence devices based on the event information received from the event occurrence devices, and detect the abnormal event based on the event occurring frequency of each of the event occurrence devices.
